(19) United States
(12) Patent Application Publication
(10) Pub. No.: US 2011/0194811 A1
(43) Pub. Date: Aug. 11, 2011

(54) FIBER OPTIC ROTARY JOINT AND ANTENNA, ANTENNA MEASUREMENT SYSTEM, AND WIRELESS COMMUNICATION SYSTEM

(75) Inventors: In-Kui Cho, Daejon (KR); Sung-Woong Choi, Daejon (KR); Je-Hoon Yun, Daejon (KR)

(73) Assignee: Electronics and Telecommunications Research Institute, Daejon (KR)

(21) Appl. No.: 13/123,549

(22) PCT Filed: Jul. 16, 2009
(86) PCT No.: PCT/KR09/03940

§ 371 Date: Apr. 11, 2011

(30) Foreign Application Priority Data
Oct. 31, 2008 (KR) 10-2008-0107724

(51) Int. Cl. G02B 6/26

(52) U.S. Cl. 385/25

(57) ABSTRACT

Provided are a fiber optic rotary joint, an antenna having the same, an antenna measurement system, and a wireless communication system. An antenna measurement system includes an electro-optic converting unit for converting an electric signal to an optical signal, a first optical fiber for transferring the converted optical signal from the electro-optic converting unit, a second optical fiber having a diameter larger than the first optical fiber and transferring the optical signal outputted from the first optical fiber, an align unit for aligning the first optical fiber with the second optical fiber, and an opto-electric converting unit for converting the optical signal outputted from the second optical fiber to the electric signal.

### TECHNICAL FIELD

The present invention relates to a fiber optic rotary joint, an antenna having the same, an antenna measurement system, and a wireless communication system.

### BACKGROUND ART

A radio frequency (RF) cable connected to an antenna influences an electromagnetic wave when antenna properties are measured or when electromagnetic compatibility (EMC) is measured. Such influence disturbs accurately measuring the antenna properties and EMC. The RF cable functions as a secondary radiator due to current formed on an exterior shield of the RF cable. The formed current influences the electromagnetic wave. In general, an antenna rotates while the antenna properties are measured. Accordingly, a cable connected to the antenna rotates together with the antenna. Due to such movement of the cable, error occurs in a measurement result. Particularly, the error becomes significant in the measurement result when a cable vertically connected to a vertical antenna moves. Such an error may be in a range of 7 dB to 10 dB.

In order to minimize the influence of the RF cable in antenna property measurement or EMC measurement, various methods have been introduced. As a representative method, ferrite beads are used. Since ferrite beads minimize forming current at the RF cable, the ferrite beads effectively reduce the error in the measurement result. However, the ferrite beads are not effective in GHz-level frequency bands although ferrite beads are effective in MHz-level frequency bands. As another method for reducing the influence of the RF cable, a sleeve balun having a ¼ wavelength was attached to an RF cable. However, the sleeve balun is also effective in a limited frequency band since the balun structurally has a limited bandwidth.

FIG. 1 is a diagram illustrating an antenna measurement system 100 according to the prior art.

Antenna properties are measured inside a radio anechoic chamber. The radio anechoic chamber prevents the reflection of electromagnetic wave from a wall of the radio anechoic chamber to an antenna and protects an antenna from external electromagnetic wave not to be influenced. In FIG. 1, a region I denotes the inside of a radio anechoic chamber and a region II denotes the outside of a radio anechoic chamber.

As shown in FIG. 1, the conventional antenna measurement system 100 includes a dipole antenna 104, a balun 106, an antenna support 108, an RF cable 110, ferrite beads 112, and a digital voltmeter 114. The antenna support 118 fixes the dipole antenna 104 in the region I. The dipole antenna 104 receives a signal 102 radiated from a transmission antenna (not shown). In order to accurately measure the properties of the dipole antenna 104, the transmission antenna transmits a predetermined frequency signal 102 having a uniform output power.

The signal received by the dipole antenna 104 is transferred by the RF cable 110 through the balun 106. The RF cable 110 includes the ferrite beads 112 at a predetermined interval, for example, 15 cm. The ferrite beads 112 are disposed by passing the RF cable through a pipe shaped ferrite core or winding the RF cable 110 around a pipe shaped ferrite core. The ferrite beads prevent the RF cable 110 from functioning as a radiator. The signal received by the dipole antenna 104 is transferred through the RF cable 110 and is inputted to the digital voltmeter 114 disposed in the region II. The digital voltmeter 114 measures the intensity of the received signal.

It may be necessary to rotate an antenna to measure the property of the antenna 104. In this case, the RF cable 110 rotates along the antenna 104 and increases the influence in the antenna property measurement result. As described above, the ferrite beads 112 are not effective in a GHz-level frequency band although the ferrite beads 112 effectively reduce the radiation of electromagnetic wave of the RF cable 110. The balun 106 of ¼ wavelength is also effective only at a limited frequency band although the balun 106 is used to reduce the radiation of the electromagnetic wave of the RF cable 110 in a radio frequency band.

### DISCLOSURE

### Technical Problem

An embodiment of the present invention is directed to providing an antenna, an antenna measurement system, and a wireless communication system for reducing the influence of an electromagnetic wave of a cable using an optical fiber and a fiber optic rotary joint.

Another embodiment of the present invention is directed to providing a fiber optic rotary joint for reducing the variation of insertion loss that may be generated due to change of an optical axis caused by the rotation of the fiber optic rotary joint.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided an antenna measurement system, including an electro-optic converting unit for converting an electric signal to an optical signal, a first optical fiber for transferring the converted optical signal from the electro-optic converting unit, a second optical fiber having a diameter larger than the first optical fiber and transferring the optical signal outputted from the first optical fiber, an align unit for aligning the first optical fiber and the second optical fiber, and an opto-electric converting unit for converting the optical signal outputted from the second optical fiber to the electric signal.

In accordance with another aspect of the present invention, there is provided a fiber optic rotary joint, including a first optical fiber for transferring an optical signal, a second optical fiber having a diameter larger than the first optical fiber and for outputting the optical signal outputted from the first optical fiber, and an align unit for aligning the first and second optical fibers.

In accordance with another aspect of the present invention, there is provided an antenna including an electro-optic converting unit for converting an electric signal to an optical signal, a first optical fiber for transferring the optical signal converted by the electro-optic converting unit, a second optical fiber having a diameter larger than the first optical fiber and transferring the optical signal outputted from the first optical fiber, an align unit for aligning the first and second optical fibers, and an opto-electric converting unit for converting the optical signal outputted from the second optical fiber to the electric signal.

In accordance with another aspect of the present invention, there is provided a wireless communication system including an electro-optic converting unit for converting an electric signal to an optical signal, a first optical fiber for transferring the optical signal converted by the electro-optic converting unit, a second optical fiber having a diameter greater than the first optical fiber and transferring the optical signal outputted from the first optical fiber, an align unit for aligning the first and second optical fibers, an opto-electric converting unit for converting the optical signal outputted from the second optical fiber to the electric signal, and an antenna for transferring the electric signal to the electro-optic converting unit and receiving the electric signal from the opto-electric converting unit.

### Advantageous Effects

A fiber optic rotary antenna according to the present invention can reduce error caused by a cable in an antenna, an antenna measurement system, and a wireless communication system. Furthermore, the fiber optic rotary antenna according to the present invention can reduce variation of insertion loss, which is caused by optical axis change during rotation of an optic rotary joint.

### BRIEF DESCRIPTION OF THE DRAWINGS

FIG. 1 is a diagram illustrating an antenna measurement system according to the prior art.

FIG. 2 is a diagram illustrating a fiber optic rotary joint in accordance with an embodiment of the present invention.

FIG. 3 is a diagram illustrating a fiber optic rotary joint in accordance with another embodiment of the present invention.

FIG. 4 is a diagram illustrating an antenna in accordance with an embodiment of the present invention.

FIG. 5 is a diagram illustrating an antenna measurement system in accordance with an embodiment of the present invention.

FIG. 6 is a diagram illustrating an antenna measurement system in accordance with another embodiment of the present invention.

FIG. 7 is a graph showing a result of simulating insertion loss of a fiber optic rotary joint in accordance with an embodiment of the present invention.

FIG. 8 is a graph illustrating a result of simulating insertion loss of fiber optic rotary joint in accordance with an embodiment of the present invention.

FIG. 9 is a graph illustrating a result of simulating insertion loss of a fiber optic rotary joint in accordance with an embodiment of the present invention.

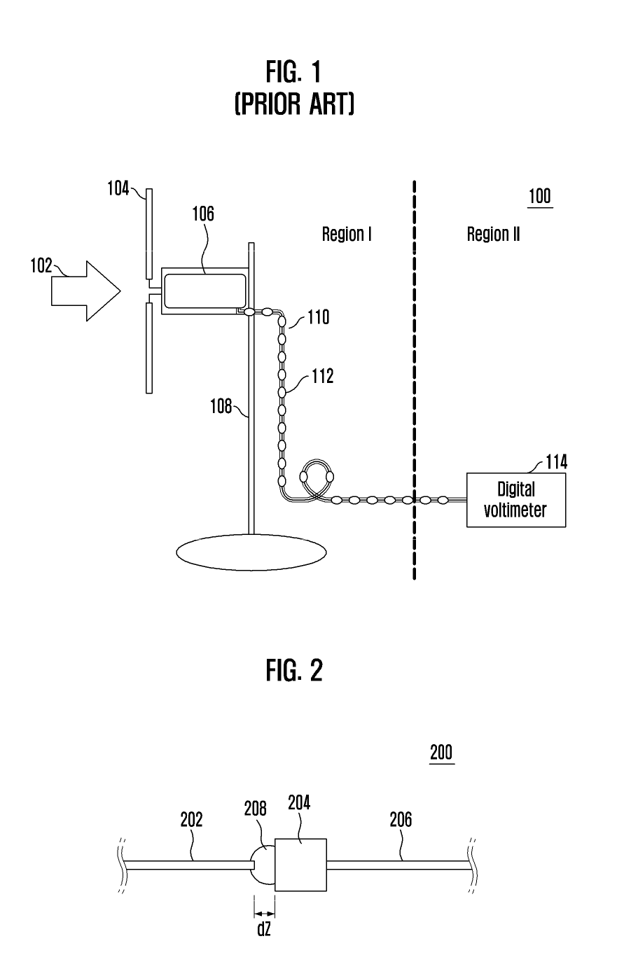

### BEST MODE FOR THE INVENTION

The advantages, features and aspects of the invention will become apparent from the following description of the embodiments with reference to the accompanying drawings, which is set forth hereinafter.

FIG. 2 is a diagram illustrating a fiber optic rotary joint 200 in accordance with an embodiment of the present invention.

As shown in FIG. 2, the fiber optic rotary joint 200 according to the embodiment of the present invention includes a first optical fiber 202, a second optical fiber 204, a third optical fiber 206, and a matching oil 208.

The first optical fiber 202 transfers an optical signal. The second optical fiber 204 has a diameter larger than that of the first optical fiber 202. The second optical fiber 204 transfers the optical signal outputted from the first optical fiber. The first and second optical fibers 202 and 204 are disposed at a predetermined gap dZ. When an optical signal passes through the gap between the first and second optical fibers 202 and 204, a part of the optical signal may be reflected. Such a phenomenon is referred to as Fresnel Reflection in which a part of light is reflected when the light passes through a planar boundary surface formed of two mediums having different refraction indexes. If a reflected optical signal propagates to an original light source due to the Fresnel Reflection in the optic rotary joint 200, the reflected optical signal may become a serious noise in a system. The matching oil 208 in the gap minimizes such the Fresnel reflection. In the present embodiment, the gap between the first optical fiber 202 and the second optical fiber 204 may be filled with air or resin as well as the matching oil 208.

As shown in FIG. 2, the third optical fiber 206 is connected to the second optical fiber 204 and transfers an optical signal transferred to the second optical fiber. A fusion splice may be used to combine the second optical fiber 204 and the third optical fiber 206. The align unit (not shown) support each of the first, second, and third optical fibers 202, 204, and 206 to be aligned as shown in FIG. 2. One of the first optical fiber 202 and the combination of the second and third optical fibers 204 and 206 can rotate around a central axis of the optical fiber as a center with the first, second, and third optical fibers aligned as shown in FIG. 2. The first optical fiber 202 and the third optical fiber 206 may be formed of a single mode fiber SMF, and the second optical fiber 204 may be formed of a multi-mode fiber MMF. The single mode optical fiber is designed to transmit one optical signal and used to transmit a signal in a long distance. The multi-mode optical fiber is designed to transmit a plurality of optical signals at the same time and used to transmit a signal in comparatively short distance. The multi-mode optical fiber has a diameter larger than the single mode optical fiber. The second optical fiber 204 may have a predetermined length, for example, 1 cm to 20 cm. The thermally expanded core fiber (TEC fiber) may be used as at least one of the optical fibers 202, 204, and 206.

Insertion loss is generated at a gap between the first and second optical fibers 202 and 204 due to structural characteristics of the optic rotary joint 200. In general, optical fibers having the same diameter are used as the first and second optical fibers 202 and 204. In the present embodiment, an optical fiber having a diameter larger than the first optical fiber 202 is used as the second optical fiber 204 in the optic rotary joint 200 in order to minimize variation of insertion loss, which is changed due to the rotation of one of the first and second optical fibers 202 and 204. Although the optical fibers 202, 204, and 206 are aligned to match all central axes of the optical fibers 202, 204, and 206, one of the central axes may be tilted while one of the optical fibers 202, 204, and 206 rotates. When the first and second optical fibers 203 and 204 have the same diameter, the insertion loss becomes significantly changed when the optical axis is changed. In this case, the rotation causes minimum 0.5 dB variation in insertion loss when a fiber optic rotary joint is driven. However, the insertion loss is not significantly changed although the central axes of the first and second optical fibers 202 and 204 are slightly miss-matched if the diameter of the second optical fiber 204 is larger than that of the first optical fiber 202. The fiber optic rotary joint 200 is used for rotating optical fibers. The fiber optic rotary joint 200 minimizes the variation of insertion loss caused by rotation. Particularly, small variation of insertion loss is more important than a small absolute value of insertion loss in a system for measuring antenna properties. The fiber optic rotary joint 200 reduces error in a measurement result of an antenna measurement system. The fiber optic rotary joint 200 according to the present embodiment can be used in an antenna, an antenna measurement system, and a wireless communication system having an antenna.

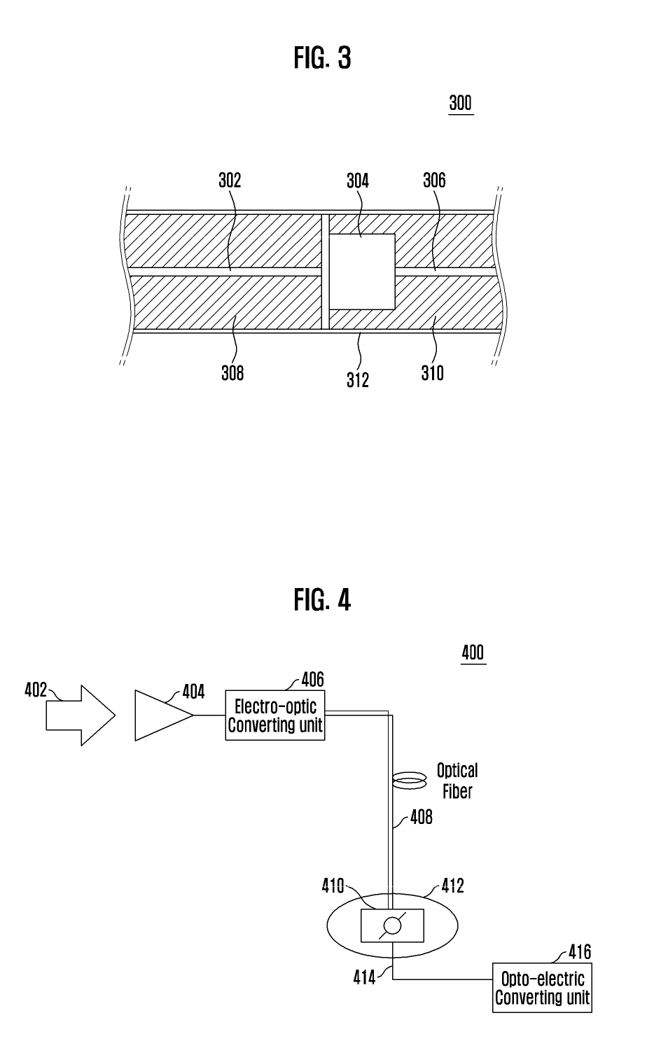

FIG. 3 is a diagram illustrating a fiber optic rotary joint 300 in accordance with another embodiment of the present invention.

As shown in FIG. 3, the fiber optic rotary joint 300 according to the present embodiment includes a first optical fiber 302, a second optical fiber 304, a third optical fiber 306, a first support 308, a second support 310, and an align sleeve 312.

The first support 308 supports the first fiber optic 302 and the second support 310 supports the second and third optical fibers 304 and 306. If the fiber optic rotary joint 300 is designed to rotate the first optical fiber 302 with the combination of the second optical fiber 304 and the third optical fiber 306 fixed, the first support 308 is a rotatable member that rotates with the first optical fiber 302 and the second support 310 is a stationary member that supports the second and third optical fibers 304 and 306. Ferrule may be used as the first and second supports 308 and 310. Although it is not shown in FIG. 3, a bearing structure may be used for precious rotation of the rotatable member. The align sleeve 312 aligns the first, second, and third optical fibers 302, 304, and 306 by surrounding the first and second supports 308 and 310.

FIG. 4 is a diagram illustrating an antenna 400 in accordance with an embodiment of the present invention.

As shown in FIG. 4, the antenna 400 according to the present invention includes an antenna radiator 404, an electro-optic converting unit 406, a first optical fiber 408, a fiber optic rotary joint 410, a rotation plate 412, a second optical fiber 414, and an opto-electric converting unit 416.

The antenna radiator 404 receives a signal 402 transmitted from a transmission antenna. As the antenna radiator 404, a half-wave standard dipole antenna may be used in a frequency band lower than 1 GHz, or a horn antenna may be used in a frequency band of about 1 GHz to 4 GHz. The electro-optic converting unit 406 converts the signal from the antenna radiator 404 to an optical signal. The optical signal from the electro-optic converting unit 406 is transferred to the opto-electric converting unit 416 through the first optical fiber 408 and the second optical fiber 414. The opto-electric converting unit 416 converts the optical signal into an electric signal again and transmits the electric signal to a system that needs the received signal 402 of the antenna radiator 404.

The antenna 400 includes the rotation plate 412 for rotating the antenna radiator 404, and the fiber optic rotary joint 410 for preventing the first and second optical fibers 408 and 414 from twisting by the rotation of the antenna radiator 404. The optic rotary joint 410 may be any one of the fiber optic rotary joints 200 and 300 shown in FIGS. 2 and 3. When the rotation plate 412 rotates, elements above the rotation plate 412 including the antenna radiator 404, the electro-optic converting unit 406, and the first optical fiber 408 rotate together. As described above, the antenna 400 can be used by changing a direction of the antenna radiator 404, and the fiber optic rotary joint 410 minimizes the variation of insertion loss caused when the antenna radiator 404 rotates.

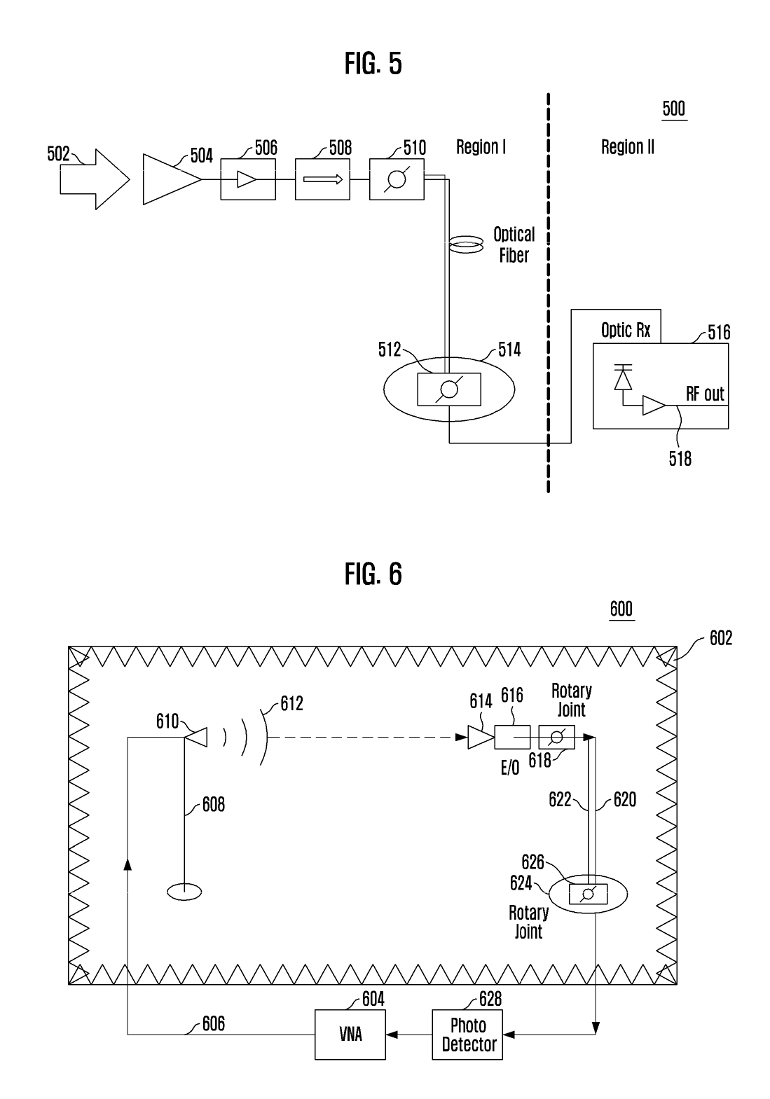

FIG. 5 is a diagram illustrating an antenna measurement system 500 in accordance with an embodiment of the present invention.

As shown in FIG. 5, the antenna measurement system 500 according to the present embodiment includes an antenna 504, an electro-optic converting unit 506, an isolator 508, a first fiber optic rotary joint 510, a second fiber optic rotary joint 512, a rotation plate 514, an opto-electric converting unit 516, and an RF output unit 518. A region I denotes the inside of a radio anechoic chamber, and a region II denotes the outside of the radio anechoic chamber.

The antenna 504 in the region I receives an RF signal 502 radiated from a transmission antenna and transfers the received RF signal 502 to the electro-optic converting unit 506. The electro-optic converting unit 506 stabilizes power of the RF signal 502 and may include a low noise amplifier (LNA) for impedance matching between the antenna 504 and the electro-optic converting unit 506. The optical signal from the electro-optic converting unit 506 is transmitted through an optical fiber. In order to control a polarization mode of the optical signal, the antenna measurement system according to the present embodiment may include a polarization mode selector. Since the optical fiber is connected to the polarization mode selector and it is necessary to rotate the optical fiber, the antenna measurement system 500 includes the first fiber optic rotary joint 510. The first fiber optic rotary joint 510 may cause Fresnel Reflection as described above. The Fresnel reflection functions as serious noise if the reflected optical signal returns to the electro-optic converting unit 506. Therefor, an isolator 508 is disposed to prevent the Fresnel Reflection.

The antenna measurement system 500 includes the second fiber optic rotary joint 512 and the rotation plate 514 because it is necessary to change a direction of the antenna 504 to measure the property of the antenna 504. The optical signal passing through the second fiber optic rotary joint 512 is transferred to the region II of the radio anechoic chamber through the optical fiber. The first and second fiber optic rotary joints 510 and 512 may be the fiber optic rotary joints 200 and 300 shown in FIGS. 2 and 3. The opto-electric converting unit 516 converts the received optical signal to an electric signal at the outside of the radio anechoic chamber and transfers the electric signal to the measurement apparatus (not shown).

The antenna measurement system 500 does not generate error in measurement because the antenna measurement system 500 transfers a signal of the antenna 504 through an optical fiber in the radio anechoic chamber unlike the conventional antenna measurement system that transfers a signal through an RF cable. The antenna measurement system 500 also includes the fiber optic rotary joint for rotating the antenna 504 without twisting the optical fibers. The antenna measurement system 500 can significantly minimize variation of insertion loss, which is caused by the rotation of the optical fibers, by using the fiber optic joint. The fiber optic rotary joint according to the present embodiment can be realized in small size compared to an RF rotary joint, can be utilized regardless of a frequency band. The optic rotary joint can be manufactured at a low cost using a direct modulation scheme. Therefore, the antenna measurement system 500 according to the present embodiment can effectively measure antenna properties.

FIG. 6 is a diagram illustrating an antenna measurement system 600 in accordance with another embodiment of the present invention.

The antenna measurement system 600 according to the present embodiment includes a radio anechoic chamber 602. Also, the antenna measurement system 600 according to the present embodiment includes a transmission antenna 610 and a reception antenna 614 inside the radio anechoic chamber 602 and includes a vector network analyzer (VNA) 604 outside the radio anechoic chamber 602. The transmission antenna 610 and the reception antenna 614 are fixed by a first antenna support 608 and a second antenna support 622. The reception antenna 614 is sequentially connected to an electro-optic converting unit 616, a first fiber optic rotary joint 618, an optical fiber 620, and a fiber optic rotary joint 626.

The vector network analyzer 604 transfers a signal for measuring the property of the reception antenna 614 to the transmission antenna 610 disposed inside the radio anechoic chamber 602 through an RF cable 606. The transmission antenna 610 copies the received signal 612 and the reception antenna 614 receives the copied signal from the transmission antenna 610 and transfers the received signal to the electro-optic converting unit 616. A low-pass noise amplifier amplifies the copied signal before the electro-optic converting unit 616 receives the copied signal. The electro-optic converting unit 616 includes a distributed feedback laser diode (DFB LD), a photo detector, and an optical fiber. The reception antenna 614 is connected to the electro-optic converting unit 616 through a subminiature coaxial (SMA) connector.

The electro-optic converter 616 converts the received signal to an optical signal and transfers the optical signal to a photo detector 628 through the optical fiber 620. A fiber optic rotary joint 618 for smoothing the rotation of the optical fiber to select a polarization mode and a fiber optic rotary joint 626 for rotating the receiving antenna 614 are disposed at the middle of the optical fiber 620. The reception antenna 614 can rotate in a range of 360° by a rotation plate 624 with the second antenna support 622. The photo detector 628, which is an opto-electric converting unit, is disposed outside the radio anechoic chamber 602. The photo detector 628 converts the received optical signal to an electric signal and transfers the electric signal to the vector network analyzer 604. The vector network analyzer 604 sets up a port outputting a first signal as a first port, and sets up a port receiving a signal from the photo detector 628 as a second port. The vector network analyzer 604 can calculate S-parameters such as S21 as a transfer function of an overall system.

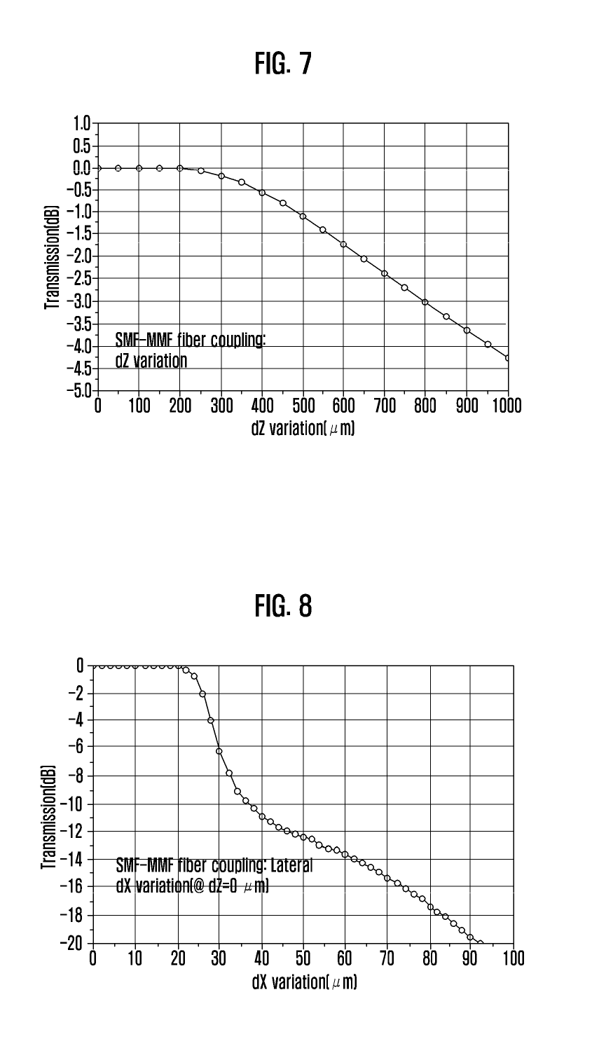

FIGS. 7 to 9 are graphs showing simulation result of insertion loss of a fiber optic rotary joint in accordance with an embodiment of the present invention.

The graphs shown in FIGS. 7 to 9 are a result of simulation using the fiber optic rotary joint 200 shown in FIG. 2. Hereinafter, the simulation result will be described with reference to FIG. 2.

As the first and third optical fibers 202 and 206 of the fiber optic rotary joint 200, a single mode fiber (SMF) is used. As the second optical fiber 204, a multimode fiber (MMF) is used. The second optical fiber 204 and the third optical fiber 206 are connected using a fusion splice. Table 1 shows simulation conditions for each of optical fibers 202, 204, and 206.

TABLE 1

| | SMF | MMF |
|---|---|---|
| Width | 8.5 μm | 50 μm |
| Height | 8.5 μm | 50 μm |
| N_{core} | 1.4483 | 1.4585 |
| N_{clad} | 1.444 | 1.444 |
| Remark | Circular step index | Circular step index profile |
| | profile | in the lateral direction |

In Table 1, Width and Height denote widths and thicknesses of a SMF and a MMF. A cross section of the SMF is a circle having a diameter of 8.5 μm. A cross-section of the MMF is a circle having a diameter of 50 μm. N_{core} denotes a core refractive index and N_{clad} is a clad refractive index.

FIG. 7 is a graph showing a result of measuring insertion loss while changing a gap dZ shown in FIG. 2 after matching central axes of all optical fibers 202, 204, and 206. The graph shows that the insertion loss is below 0.5 dB when the gap dZ is shorter than 400 μm, that is, when a distance between the first optical fiber 202 and the second optical fiber 204 is shorter than 400 μm.

FIG. 8 is a graph showing a result of measuring insertion loss while moving the first optical fiber 202 in parallel as long as dX in an orthogonal direction of an optical axis and sustaining the gap dZ as 0 μm. The graph of FIG. 8 shows that the insertion loss is about 0 dB when the gap dZ is 0 μm, that is, when the central axes of the first and second optical fibers 202 and 204 are matched. The graph of FIG. 8 shows that the insertion loss sustains less than 0.5 dB within about 25 μm of dZ although the dX increases.

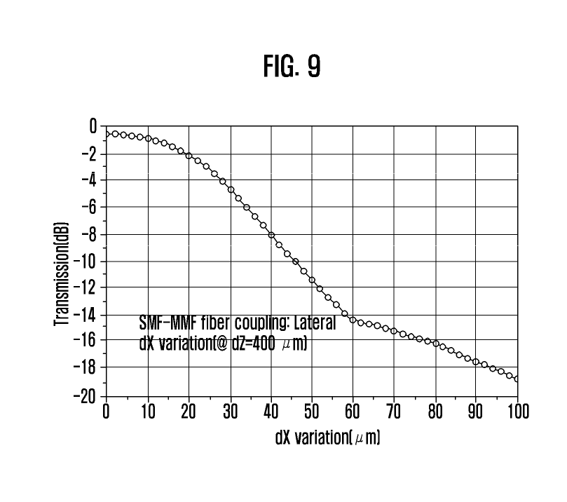

FIG. 9 is a graph showing a result of measuring insertion loss while moving the first optical fiber 202 in parallel as long as dx in an orthogonal direction of an optical axis with sustaining a gap dZ as about 400 μm. The graph of FIG. 9 shows that the insertion loss is about 0.5 dB when dX is 0 μm, that is, when the central axes of the first and second optical fibers 202 and 204 are matched. Although dx increases to about 12 μm because the central axes of the first and second optical fibers 202 and 204 are tilted, the insertion loss is sustained at about 1 dB. The variation of insertion loss is comparatively small for example about 0.5 dB. Therefore, the optic rotary joint 200 according to the present embodiment minimizes the variation of the insertion loss although the optical axes are titled.

The above described method according to the present invention can be embodied as a program and stored on a computer readable recording medium. The computer readable recording medium is any data storage device that can store data which can be thereafter read by the computer system. The computer readable recording medium includes a read-only memory (ROM), a random-access memory (RAM), a CD-ROM, a floppy disk, a hard disk and an optical magnetic disk.

The present application contains subject matter related to Korean Patent Application No. 10-2008-0107724, filed in the Korean Intellectual Property Office on Oct. 31, 2008, the entire contents of which is incorporated herein by reference.

While the present invention has been described with respect to the specific embodiments, it will be apparent to those skilled in the art that various changes and modifications may be made without departing from the spirit and scope of the invention as defined in the following claims.

What is claimed is:

1. An antenna measurement system, comprising:
an electro-optic converting unit for converting an electric signal to an optical signal;
a first optical fiber for transferring the converted optical signal from the electro-optic converting unit;
a second optical fiber having a diameter larger than the first optical fiber and transferring the optical signal outputted from the first optical fiber;
an align unit for aligning the first optical fiber with the second optical fiber; and
an opto-electric converting unit for converting the optical signal outputted from the second optical fiber to the electric signal.

2. The antenna measurement system of claim 1, wherein any one of the first and second optical fibers rotates while being aligned by the align unit.

3. The antenna measurement system of claim 1, wherein the align unit includes:
a first support for supporting the first optical fiber;
a second support for supporting the second optical fiber; and
an align sleeve for aligning the first and second optical fibers.

4. The antenna measurement system of claim 1, wherein the align unit aligns the first optical fiber with the second optical fiber to match a central axis of the first optical fiber with a central axis of the second optical fiber.

5. The antenna measurement system of claim 1, wherein the align unit aligns the first and second optical fibers to form a predetermined gap between the first and second optical fibers.

6. The antenna measurement system of claim 1, further comprising:
an isolator between both ends of the first optical fiber.

7. The antenna measurement system of claim 1, further comprising:
a polarization mode selector for selecting a polarization mode for the optical signal transferred through one of the first optical fiber and the second optical fiber,
wherein at least any one of the first and second optical fibers is connected to the polarization mode selector.

8. The antenna measurement system of claim 1, wherein the first optical fiber is a single mode fiber (SMF) and the second optical fiber is a multi-mode fiber (MMF).

9. The antenna measurement system of claim 1, wherein at least one of the first and second optical fibers is a thermally expanded core fiber (TEC fiber).

10. A fiber optic rotary joint, comprising:
a first optical fiber for transferring an optical signal;
a second optical fiber having a diameter larger than the first optical fiber and for outputting the optical signal outputted from the first optical fiber; and
an align unit for aligning the first and second optical fibers.

11. An antenna, comprising:
an electro-optic converting unit for converting an electric signal to an optical signal;
a first optical fiber for transferring the optical signal converted by the electro-optic converting unit;
a second optical fiber having a diameter larger than the first optical fiber and transferring the optical signal outputted from the first optical fiber;
an align unit for aligning the first and second optical fibers; and
an opto-electric converting unit for converting the optical signal outputted from the second optical fiber to the electric signal.

12. The antenna of claim 11, wherein any one of the first and second optical fibers rotates while being aligned by the align unit.

13. The antenna of claim 11, wherein the align unit includes:
a first support for supporting the first optical fiber;
a second support for supporting the second optical fiber; and
an align sleeve for aligning the first and second optical fibers.

14. The antenna of claim 11, wherein the align unit aligns the first and second optical fibers to match a central axis of the first optical fiber with a central axis of the second optical fiber.

15. The antenna of claim 11, wherein the align unit aligns the first and second optical fibers to form a predetermined gap between the first and second optical fibers, and the predetermined gap is filled with one of air, oil, and resin.

16. The antenna of claim 11, further comprising:
an isolator between both ends of the first optical fiber.

17. The antenna of claim 11, further comprising:
a polarization mode selector for selecting a polarization mode for the optical signal transferred through one of the first and second optical fibers, and
at least one of the first and second optical fibers is connected to the polarization mode selector.

18. The antenna of claim 11, wherein the first optical fiber is a single mode fiber (SMF) and the second optical fiber is a multi-mode fiber (MMF).

19. The antenna of claim 11, wherein at least any one of the first and second optical fibers is a thermally expanded core (TEC) fiber.

20. A wireless communication system, comprising:
an electro-optic converting unit for converting an electric signal to an optical signal;
a first optical fiber for transferring the optical signal converted by the electro-optic converting unit;
a second optical fiber having a diameter greater than the first optical fiber and transferring the optical signal outputted from the first optical fiber;
an align unit for aligning the first and second optical fibers;
an opto-electric converting unit for converting the optical signal outputted from the second optical fiber to the electric signal; and
an antenna for transferring the electric signal to the electro-optic converting unit and receiving the electric signal from the opto-electric converting unit.
